(19) United States
(12) Patent Application Publication
(10) Pub. No.: US 2011/0131976 A1
(43) Pub. Date: Jun. 9, 2011

(54) Exhaust gas turbocharger for an internal combustion engine

(76) Inventors: Stephan Krätschmer, Schwabisch Gmund (DE); Paul Löffler, Stuttgart (DE); Markus Müller, Waiblingen (DE); Siegfried Sumser, Stuttgart (DE)

(21) Appl. No.: 12/927,868

(22) Filed: Nov. 27, 2010

Related U.S. Application Data
(63) Continuation-in-part of application No. PCT/EP2009/006550, filed on Sep. 9, 2009.

(30) Foreign Application Priority Data
Sep. 30, 2008 (DE) 10 2008 049 782.7

(51) Int. Cl. F02C 6/12

(52) U.S. Cl. 60/602

(57) ABSTRACT

In an exhaust gas turbocharger for an internal combustion engine having a housing comprising an exhaust gas guide segment, an air guide segment, and a bearing segment, and a rotor assembly comprising a turbine wheel having a plurality of blades, a compressor wheel, and a shaft rotationally fixing the turbine wheel (5) to the compressor wheel, wherein the turbine wheel is rotationally supported in the exhaust gas guide segment and the compressor wheel is rotationally supported in the air guide segment and the shaft is rotationally supported in the bearing segment and, wherein the turbine wheel is acted on by exhaust gas from the internal combustion engine for driving the rotor assembly, a sleeve-shaped sliding element is positioned in the exhaust gas guide segment for conditioning the exhaust gas flow acting on the turbine wheel.

This is a Continuation-In-Part Application of pending international patent application PCT/EP2009/00655 filed Sep. 9, 2009 and claiming the priority of German patent application 10 2008 049 782.7 filed Sep. 30, 2008.

### BACKGROUND OF THE INVENTION

The invention relates to an exhaust gas turbocharger for an internal combustion engine having a housing with an exhaust gas guide segment, an air guide segment and a bearing segment and a rotor assembly with a turbine wheel, a compressor wheel and a shaft rotationally interconnecting the turbine wheel and the compressor wheel.

A continuous reduction of emission limit values, in particular the limit values of NOₓ and soot emissions of internal combustion engines charged by means of exhaust gas turbochargers affects design and thermodynamic characteristic values of the exhaust gas turbocharger. A high charge pressure, which should already be available in the medium load region of the internal combustion engine for an effective exhaust gas recirculation thus requires a size reduction of a turbine of the exhaust gas turbo-charger, since, due to the increase of a back pressure capability or reduction of an absorption capacity of the turbine caused thereby, a high turbine performance can be achieved already at low speeds.

Additionally, a soot filter connected downstream of the turbine leads to a pressure increase downstream of the turbine, which for achieving a correspondingly high turbine performance can be compensated for by an increase of the pressure upstream of the turbine. This pressure increase however can also be achieved by a size reduction of the turbine.

The patent specification U.S. Pat. No. 4,776,168 discloses an exhaust gas turbocharger for an internal combustion engine, wherein the exhaust gas turbocharger has a housing with an exhaust gas guide segment, an air guide segment and a bearing segment. A rotor assembly positioned in the housing comprises a turbine wheel with a plurality of blades, a compressor wheel and a shaft connecting the turbine wheel to the compressor wheel in a rotationally fixed manner, wherein the turbine wheel is supported rotationally in the exhaust gas guide segment and the compressor wheel in the air guide segment and the shaft is rotationally supported in the bearing segment. The turbine wheel can be acted on by exhaust gas from the internal combustion engine, wherein the compressor wheel can be driven via the shaft by the turbine wheel for taking in and compressing air. A sleeve-shaped sliding element is positioned in the exhaust gas guide segment for conditioning the exhaust gas acting on the turbine wheel.

The sleeve-shaped sliding element is positioned upstream of the turbine wheel in such a manner that a flow passage associated with a spiral channel in the exhaust gas guide segment can be changed in its cross section. By means of this sliding element, an enthalpy drop of the flow medium, in this case exhaust gas, can be adjusted at the turbine wheel, wherein the enthalpy drop can be depicted as the difference of the enthalpy in front of the turbine wheel and the enthalpy behind the turbine wheel. By means of the sleeve-shaped sliding element, the enthalpy in front of the turbine wheel can be influenced.

A characteristic value of the turbine of the exhaust gas turbocharger is a so-called reaction level of the turbine, in the following called turbine reaction level, which is related to the quotient of the flow speed change in the turbine wheel and the total enthalpy drop of the turbine. Usually, the flow cross section of the flow passage or of the spiral inlet duct and the following nozzle is adapted to the flow passage cross section of the turbine wheel outlet for optimizing the turbine in such a manner that a first half of an exergy of the flow medium is converted to speed energy in front of the turbine wheel and a second half of the exergy is converted to speed energy in a turbine wheel blade channel delimited respectively by two turbine blades, wherein a part of the exergy is the enthalpy.

Due to the high demands on the acceleration behavior or transient behavior of the exhaust gas turbocharger, when using variable elements as for example a sleeve-shaped slider element or rotatable guide blades upstream of the turbine wheel, generally the part of the exergy of the flow medium, which is converted to speed energy in front of the turbine wheel, was greater than the part of the exergy, which was converted to speed energy in the turbine blade channel. The turbine reaction level of the turbines nowadays especially used in motor vehicle, is usually at a value below 0.5. Maximum turbine efficiency however can be achieved in the region of a turbine reaction level of 0.5.

It is the object of the present invention to provide an exhaust gas turbocharger which has an improved turbine efficiency with a simultaneous variability of the turbine reaction level by influencing the energy that can be converted to speed energy in the turbine blade channel.

### SUMMARY OF THE INVENTION

An exhaust gas turbocharger, which has an improved transient behavior with a simultaneous variability of a turbine reaction level by influencing the energy that can be converted to speed energy in the turbine wheel blade channel, is obtained according to the invention in that the sleeve-shaped sliding element is provided which at most partially receives an outer blade contour of the turbine wheel. A free flow cross section in the turbine wheel blade channel is then controllable. The free flow cross section in the turbine wheel blade channel is the value, by which thermodynamic values, as for example pressure and speed in front of, and in, the turbine wheel blade channels can be controlled. The part of the exergy which can be converted to speed energy in the turbine wheel blade channel can thereby be influenced, so that the turbine reaction level can be varied in the turbine wheel blade channel via the speed energy. A turbine reaction level can be adjusted to a value of at least 0.5. Small turbines can thus advantageously be used during the operation of an internal combustion engine, whereby the acceleration behavior of the exhaust gas turbocharger can be improved resulting e.g. in a reduction of the known “turbo hole”. This leads to an efficiency increase of the entire system exhaust gas turbocharger-internal combustion engine, whereby fuel consumption of the internal combustion engine is reduced. In this way, an effective exhaust gas recirculation is achieved even at high engine loads while simultaneous sufficient fresh air is supplied to the internal combustion engine by means of the compressor of the exhaust gas turbocharger driven by the turbine, so that also fuel consumption of the internal combustion engine can be lowered.

In one arrangement, the sleeve-shaped sliding element is formed so as to accommodate the outer blade contour in an outlet region of the turbine wheel, whereby a further increase of the turbine reaction level can be achieved.

In a further arrangement, the sleeve-shaped sliding element is positioned in the exhaust gas guide segment in such a manner that in the narrowest turbine wheel cross section the exhaust gas can be conditioned. The narrowest turbine wheel cross section is important for a flow rate capacity of the turbine, as the sound passage takes place here in the turbine wheel. The turbine reaction level and therewith the turbine injectivity behavior can be influenced considerably in an advantageous manner in that a charge change work of the internal combustion engine can be controlled. By increasing the narrowest turbine wheel cross section, the charge change work can be reduced.

In a further advantageous arrangement, the sleeve-shaped sliding element has a free flow cross section, which is formed in the shape of a truncated cone integrated over a first length, corresponding to a nozzle, wherein a first flow cross section is larger by a small gap than a turbine wheel outlet diameter so as to permit movement of the sliding element, and a second flow cross section is larger by a movement permitting gap than a second turbine wheel outlet diameter, wherein the first turbine wheel outlet diameter has a first ratio to the second turbine wheel outlet diameter, and the second ratio has a squared value which is larger than 1.1. By means of the flow cross section of the sliding element formed integrated in a manner of a truncated cone over the first length, an outlet diameter of the turbine wheel characteristic for the flow cross section change can virtually be varied, wherein the corresponding turbine wheel outlet diameter can correspondingly be adapted to an operating point of the exhaust gas turbocharger, so that an increase of the efficiency of the turbine can be achieved as the result of an increase of the turbine reaction level, e.g. at low engine speeds and high loads.

In a further arrangement, the second turbine wheel outlet diameter has a second ratio to a turbine wheel inlet diameter, wherein the second ratio squared has a value which is smaller than 0.66, so that the specific diameter of the turbine can be affected in dependence on the total turbine pressure drop and the outlet flow volume of the exhaust gas and an increase of the efficiency can be achieved thereby.

In a further advantageous arrangement, a free flow cross section of the sleeve-shaped sliding element is in the shape of a laval nozzle along a longitudinal axis of the sliding element, whereby the flow medium can be influenced when exiting the turbine wheel and flow losses can be reduced at the exit of the flow medium from the turbine wheel.

In a further arrangement, a smallest free flow cross section is positioned outside the turbine wheel in the direct vicinity of the second turbine wheel outlet diameter in a closing position of the sleeve-shaped sliding element. An axial outflow of the flow medium in the region of the narrowest turbine wheel cross section is maintained thereby. For avoiding mechanical problems, a turbine wheel blade design is thus possible, which permits a favorable swirl distribution of the flow in the absolute system even with high mass flow rates of the exhaust gas. The turbine wheel blade design is preferably oriented in the radial direction, whereby bending torques can be avoided and the operating life can thus be increased.

In a further arrangement, the exhaust gas guide segment has a first spiral channel and a second spiral channel for the inflow of the turbine wheel, whereby an improvement of the operating behavior of the exhaust gas turbocharger, in particular with an internal combustion engine with more than four cylinders, can be achieved. By means of the sliding element, a turbine reaction level of at least 0.5 can be achieved for the exhaust gas turbocharger with a first spiral channel and a second spiral channel even at high flow rates.

In a further arrangement, the first spiral channel and the second spiral channel are advantageously arranged in an asymmetric manner, wherein a first flow of the first spiral channel and a second flow of the second spiral channel have different flow cross sections. By means of the asymmetric arrangement of the spiral channels, the spiral channels can be used corresponding to their maximum flow rate. Thus, a high exhaust gas turbocharger speed can e.g. be achieved with a low flow rate when the exhaust gas is guided through the smaller spiral channel. By means of a sliding element, the turbine reaction level can be adapted for each flow, so that an improvement of fuel consumption and emission values of the internal combustion engine can be achieved.

In a further arrangement, the first spiral channel or the second spiral channel is connected to an exhaust gas recirculation line. For an improved exhaust gas recirculation, the smaller of the two flow passages is usually used, with small flow cross sections, whose flow losses are caused mainly by friction at walls of the spiral channels due to high flow velocities. By means of the sliding element it is now possible to reduce these flow losses by a corresponding design of the turbine housing, so that fuel consumption and emissions of the internal combustion engine are reduced also with exhaust gas recirculation.

In a further arrangement, the first spiral channel and/or the second spiral channel are arranged around the turbine wheel in segments for improving the response behavior and the exhaust gas recirculation functions of the exhaust gas turbocharger.

In a further arrangement, the sleeve-shaped sliding element is adjustable by means of a control unit, so that a positioning of the sliding element can be programmed and be adjusted automatically.

In a further advantageous arrangement, the sleeve-shaped sliding element can advantageously be adjusted in dependence on engine operating parameters. The adjustment can for example take place in dependence on a charge pressure which is established downstream of the compressor, and/or in dependence on a turbine inlet pressure, upstream of the turbine wheel.

Further advantages, characteristics and details of the invention will become more readily apparent from the following descriptions of several embodiments with reference to the accompanying drawings, in which the same or functionally the same elements are provided with identical reference numerals.

It is shown in:

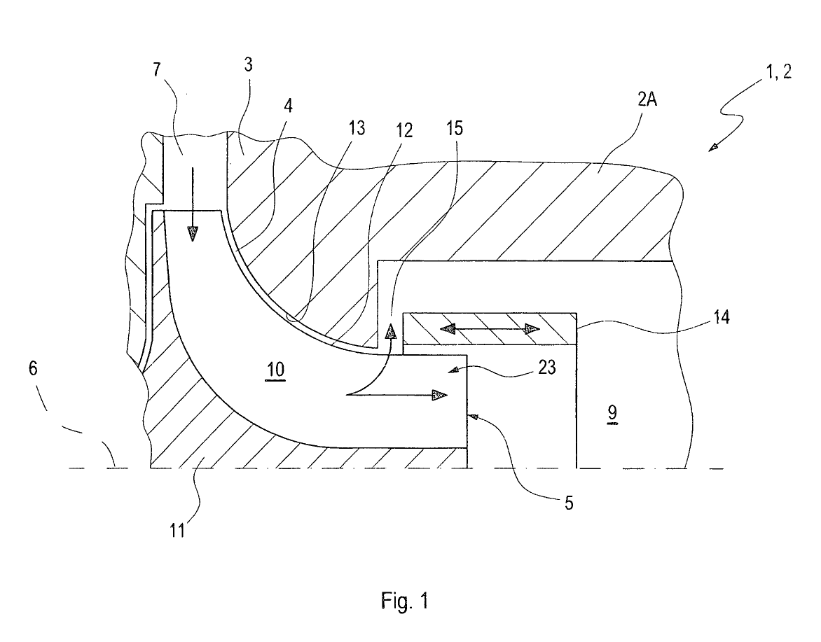

FIG. 1 a section of a turbine of an exhaust gas turbocharger according to the invention in a longitudinal section,

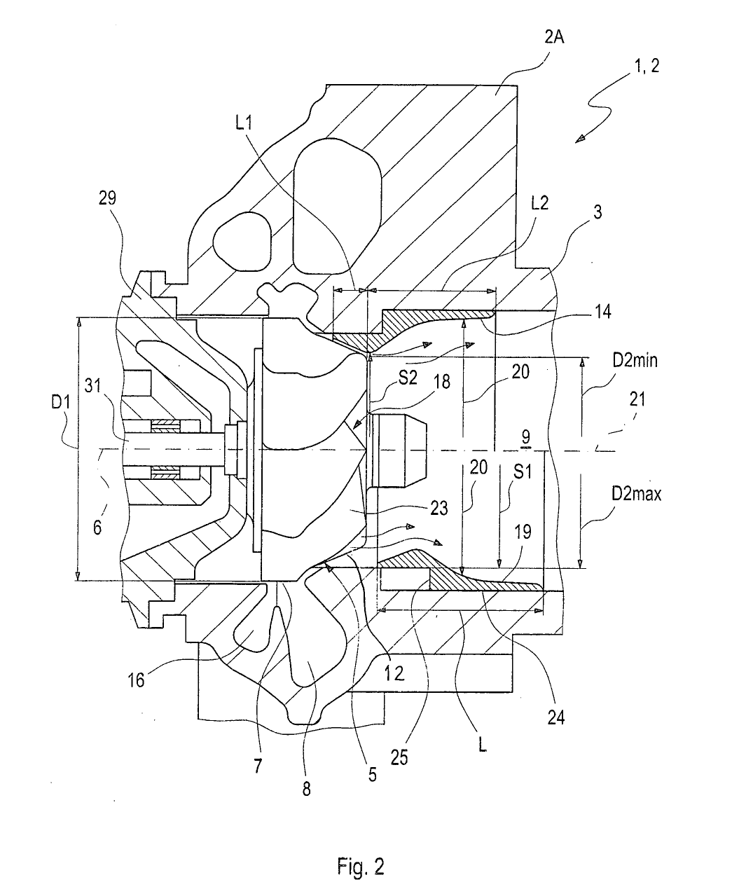

FIG. 2 the turbine of the exhaust gas turbocharger according to the invention in a longitudinal section of view,

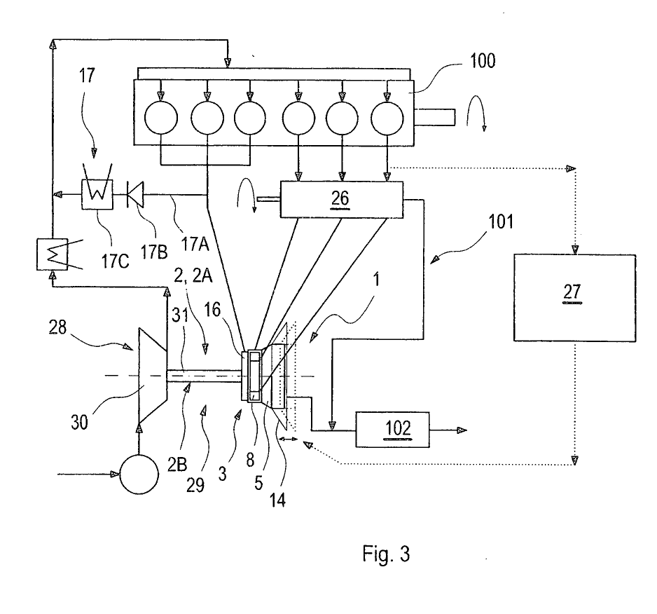

FIG. 3 schematically an internal combustion engine with an exhaust gas turbocharger according to the invention, and in

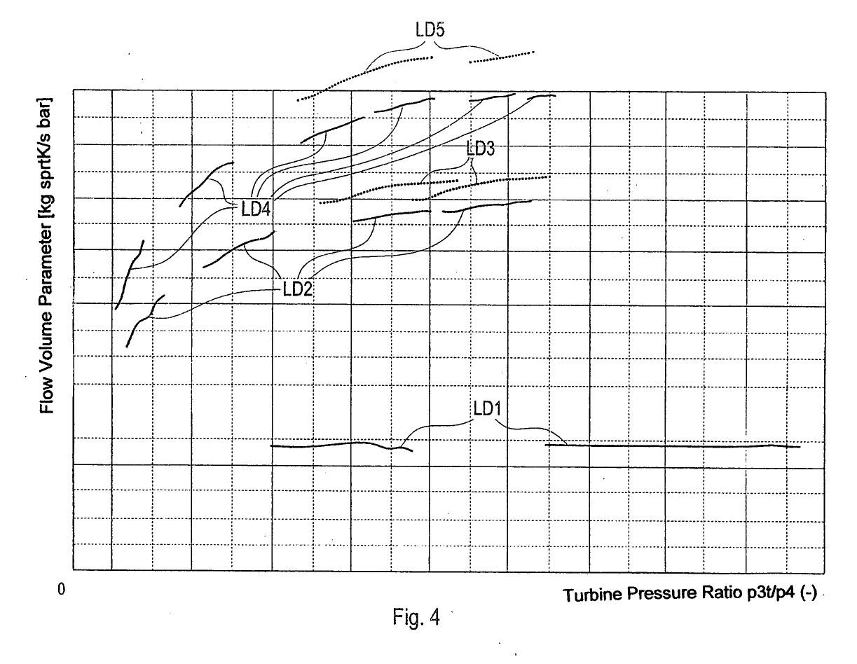

FIG. 4 a flow rate performance graph of a turbine of the exhaust gas turbocharger according to FIG. 2.

### DESCRIPTION OF PARTICULAR EMBODIMENTS

A turbine 1 of an exhaust gas turbocharger 2 shown in FIG. 1, preferably for an internal combustion engine 100 (as shown in FIG. 3), that is a gasoline or Diesel engine, has a housing 2A including an exhaust gas guide segment 3 with a wheel chamber 4, in which a turbine wheel 5 of the turbine 1 is received so as to be rotatable about a rotational axis 6. The exhaust gas turbocharger 2 further comprises an air supply segment 28 and a bearing segment 29 as parts of the housing 2A, and a rotor assembly 2B, comprising the turbine wheel 5, a compressor wheel 30 and a shaft 31 connecting the turbine wheel 5 to the compressor wheel 30 in a rotatably fixed manner. The compressor wheel 30 is rotatably disposed in the air guide segment 28 and the shaft 31 is rotationally supported in the bearing segment 29. The turbine wheel 5 can be acted on by exhaust gas from the internal combustion engine 100, whereby the turbine wheel 5 is rotated and the compressor wheel 30 is driven by way of the shaft 31 from the turbine wheel for taking in and compressing air.

A first passage 7 of a first spiral channel, not shown in detail in FIG. 1, is arranged upstream of the wheel chamber 4 in the exhaust gas guide segment 3. The exhaust gas guide segment 3 has an outlet channel 9 downstream of the wheel chamber 4. A plurality of turbine blades 10 is positioned on a hub 11 of the turbine wheel 5, wherein an outer blade contour 12 of the turbine wheel 5 is mainly limited by a wall 13 of the exhaust gas guide segment 3 in the region of the wheel chamber 4.

The turbine wheel 5 or turbine wheel blade channels 23 formed between respectively two turbine blades 10 accommodate the flow of a gaseous flow medium in the direction of the arrows, in this case exhaust gas of the internal combustion engine 100. A sleeve-shaped sliding element 14 is formed to partially receive the outer blade contour 12 in the region of the outlet channel 9, wherein the sleeve-shaped sliding element 14 is formed to receive the outer blade contour 12 in an outlet region of the turbine wheel 5. The sleeve-shaped sliding element 14 can be displaced axially.

In FIG. 1, an intermediate position of the sleeve-shaped sliding element 14 is shown, wherein an annular passage 15 is formed between an axial end of the sleeve-shaped sliding element 14 positioned facing the exhaust gas guide segment 3. A closing position of the sliding element 14 is adjusted if this annular passage 15 is closed by an axial movement of the sliding element 14 toward the turbine wheel 5. A complete opening position is present when that the annular cross section 15 completely releases the outer blade contour 12, that is, the sliding element 14 is positioned in the outlet channel 9 due to an axial movement away from the turbine wheel 5.

FIG. 2 shows a first version of the exhaust gas turbocharger 2 according to the invention, wherein the exhaust gas guide segment 3 has a first spiral channel 8 and a second spiral channel 16. The spiral channels 8, 16 are formed in an asymmetric manner in this embodiment, in particular for an effective exhaust gas recirculation. The second smaller one of the two spiral channels 8, 16 is, as shown in principle in FIG. 3, connected to an exhaust gas recirculation device 17, which comprises an exhaust gas recirculation line 17A, an exhaust gas recirculation valve 17B and an exhaust gas cooler 17C. The sleeve-shaped sliding element 14 is thereby positioned in the exhaust gas guide segment 3 in such a manner that the exhaust gas can be conditioned in a region of a narrowest turbine wheel cross section 18.

The sleeve-shaped sliding element 14 has in this embodiment an inner contour 19, wherein a free flow cross section 20 of the sleeve-shaped sliding element 14 is in the form of a level nozzle extending along a longitudinal axis 21 of the sliding element 14. The flow cross section 20 is initially formed narrowing along the longitudinal axis 21 up to a first length L1 of the sliding element 14 in a preferably continuous manner, whereby the flow cross section 20 is provided integrated in a truncated manner over the first length L1. From this first length L1, the flow cross section 20 is formed widening over a second length L2 also preferably in a continuous manner. The sum of the first length L1 and of the second length L2 corresponds to a total length L of the sliding element 14. The flow channel with the cross section 20 is in the form of a truncated cone extending over the first length L1 in a flow-favoring manner.

A first turbine wheel outlet diameter D2max is sized in a first ratio V1 to a second turbine wheel outlet diameter D2min, which corresponds to the smallest turbine wheel outlet diameter, wherein the first ratio V1 has a squared value of is 1.4. The first ratio V1 is preferably larger than 1.1.

Furthermore, in this embodiment, the second turbine wheel outlet diameter D2min of the turbine wheel 5 is determined in a second ratio V2 to a turbine wheel inlet diameter D1 of the turbine wheel 5, which has a squared value of 0.6. The exhaust gas turbocharger 2 according to the invention should preferably have the second ratio V2 at a value that is smaller than 0.66.

FIG. 2 shows the sliding element 14 in two different positions. Above the rotational axis 6, the sliding element 14 is shown in its closing position, wherein a smallest free flow cross section S2 is provided in the direct vicinity of the outlet region of the turbine wheel 5 with the second turbine wheel outlet diameter D2min, that is, of the smallest turbine wheel outlet diameter. The smallest free flow cross section S2 thereby virtually corresponds to a flow cross section with the second turbine wheel outlet diameter D2min, wherein the smallest free flow cross section S2 has to be larger by a surface amount of a movement gap due to the rotational movement, as otherwise friction or a collision can occur during the operation of the exhaust gas turbocharger 2 and in the closing position. The flow of the exhaust gas can, indicated by arrows, axially only flow from the second turbine wheel outlet diameter D2min from the turbine blade channels 23 into the outlet channel 9.

Below the rotational axis 6, the sliding element 14 is shown in its fully open position. The sliding element 14 is herein positioned displaced so far axially from the turbine wheel 5 that the flow can flow from the turbine blade channels 23 into the outlet channel 9 already from the outer blade contour 12 released by the wall 13 of the exhaust gas guide segment 3, or already from the first turbine wheel outlet diameter D2max.

In the shown embodiment, an outer contour 24 of the sliding element 14 has a securing device 25 in the form of shoulder for limiting the maximum displacement in the direction towards the turbine wheel 5, wherein this annular shoulder is formed corresponding to the wall 13 of the exhaust gas guide segment 3 in the region of the outlet channel 9. By means of the shoulder 25, the maximum displacement of the sliding element 14 in the direction of the turbine wheel 5 is thus ensured in a simple manner.

In a further arrangement, the first spiral channel 8 is arranged in segments, as shown in FIG. 3 in principle. For the exhaust gas aftertreatment, an exhaust gas aftertreatment unit 102 is associated with the internal combustion engine in an exhaust gas strand 101 of the internal combustion engine 100 downstream of the turbine 3, which is arranged in the exhaust gas strand 101 of the internal combustion engine 100. A switchover between the individual segments thereby takes place by means of a flow control device 26. The internal combustion engine 100 has a control unit 27 by means of which the flow control 26 can be adjusted amongst others and the sliding element 14 can be displaced axially. The sliding element 14 can preferably be adjusted in dependence on engine operating parameters. Instead of the shown segment turbine, a single-flow turbine with conventionally adjustable vanes in front of the turbine wheel is also conceivable, whereby a full variability is possible at the wheel inlet and according to the invention also at the wheel outlet for the optimal reaction level choice of the turbine.

FIG. 4 shows a flow rate performance graph of the turbine 1 of the exhaust gas turbocharger 2 according to the invention, wherein a flow rate parameter is plotted over a turbine pressure ratio. The lines LD1 are flow rate parameters to be expected with a closed flow passage, that is, for example in an operation of the internal combustion engine 100 with low flow rates. If the second spiral channel 16 is blocked, or no exhaust gas flows through it of the turbine wheel operated solely by exhaust gas from the first spiral channel 8. If the sliding element 14 is at the same time in its closing position, values above the turbine pressure ratio according to the lines LD2 result as flow rate parameters. An axial displacement of the sliding element 14 for opening the annular cross section 15 leads to flow rate parameters according to the lines LD3. A simultaneous acting on of both spiral channels 8, 16 and a positioning of the sliding element 14 in its closing position results in flow rate parameters according to the lines LD4, and an axial displacement of the sliding element 14 for opening the annular cross section 15 leads to flow rate parameters according to the lines LD5 and results in a substantial increase of the flow rate parameters.

Besides the development of elaborate control devices for the sliding element 14, very simple control devices for the positioning of the sliding element, e.g. with the aid of conventional cost-efficient pressure actuators can also be used for cost reasons.

What is claimed is:

1. An exhaust gas turbocharger for an internal combustion engine (100) the turbocharger (2) having a housing (2A) comprising an exhaust gas guide segment (3), an air guide segment (28), and a bearing segment (29), a rotor assembly (2B) comprising a turbine wheel (5) with a plurality of blades (10), a compressor wheel (30), and a shaft (31) rotationally connected to the turbine wheel (5) and to the compressor wheel (30), wherein the turbine wheel (5) is rotationally supported in the exhaust gas guide segment (3) and the compressor wheel (30) is rotationally supported in the air guide segment (28), and the shaft (31) by rotatably supported in the bearing segment (29), the turbine wheel (5) being acted on by exhaust gas from the internal combustion engine (100) and the compressor wheel (30) being driven via the shaft (31) by the turbine wheel (5) for taking in and compressing air, and a sleeve-shaped sliding element (14) positioned in the exhaust gas guide segment (3) for conditioning the exhaust gas acting on the turbine wheel (5), the sleeve-shaped sliding element (14) being designed for at most partially accommodating an outer blade contour (12) of the turbine wheel (5).

2. The exhaust gas turbocharger according to claim 1, wherein the sleeve-shaped sliding element (14) is shaped so as to receive the outer blade contour (12) in an outlet region of the turbine wheel (5).

3. The exhaust gas turbocharger according to claim 1, wherein the sleeve-shaped sliding element (14) is positioned in the exhaust gas guide segment (3) in such a manner that the exhaust gas can be conditioned in a region of a smallest turbine wheel cross section (18).

4. The exhaust gas turbocharger according to claim 1, wherein the sleeve-shaped sliding element (14) has a free flow cross section (20), which is in the shape of a truncated cone integrally formed over a first length (L1), wherein a first flow cross section (S1) is larger by a movement gap cross section than a flow cross section with a first turbine wheel outlet diameter (D2max), and a second flow cross section (S2) is larger by the movement gap cross section than a flow cross section with a second turbine wheel outlet diameter (D2min), wherein the first turbine wheel outlet diameter (D2max) has a first ratio (V1) to the second turbine wheel outlet diameter (D2min), and the first ratio (V1) has a squared value which is larger than 1.1.

5. The exhaust gas turbocharger according to claim 4, wherein the second turbine wheel outlet diameter (D2min) has a second ratio (V2) to a turbine wheel inlet diameter (D1) and the second ratio (V2) has a squared value that is smaller than 0.66.

6. The exhaust gas turbocharger according to claim 1, wherein a free flow cross section (20) of the sleeve-shaped sliding element (14) is designed in the shape of a laval nozzle along a longitudinal axis (21) of the sleeve-shaped sliding element (14).

7. The exhaust gas turbocharger according to claim 6, wherein, in a closing position the sleeve-shaped sliding element, a smallest free flow cross section (S2) of the sleeve-shaped sliding element (14) is positioned in the direct vicinity of the second turbine wheel outlet diameter (D2min) area.

8. The exhaust gas turbocharger according to claim 1, wherein the exhaust gas guide segment (3) has a first spiral channel (8) and a second spiral channel (16) for the inflow of exhaust gas to the turbine wheel (5).

9. The exhaust gas turbocharger according to claim 8, wherein the first spiral channel (8) and the second spiral channel (16) are designed in an asymmetric manner.

10. The exhaust gas turbocharger according to claim 8, wherein one of the first spiral channel (8) and the second spiral channel (16) is connected to an exhaust gas return line (17a).

11. The exhaust gas turbocharger according to claim 8, wherein one of the first spiral channel (8) and the second spiral channel (16) is designed so as to enclose the turbine wheel (5) in the form of segments.

12. The exhaust gas turbocharger according to claim 1, wherein an outer contour (24) of the sleeve-shaped sliding element (14) has a securing device for limiting a maximum displacement of the sleeve-shaped sliding element (14).

13. The exhaust gas turbocharger according to claim 12, wherein the securing device (25) is formed in the shape of an annular shoulder, wherein the shoulder is formed corresponding to a wall of the exhaust gas guide segment (3).

14. The exhaust gas turbocharger according to claim 1, wherein the sleeve-shaped sliding element (14) is adjustable by means of a control unit (27).

15. The exhaust gas turbocharger according to claim 14, wherein the sleeve-shaped sliding element (14) is adjustable in depending on engine operating parameters.
